(19) United States
(12) Patent Application Publication
(10) Pub. No.: US 2006/0277023 A1
(43) Pub. Date: Dec. 7, 2006

(54) Integration of always-on software applications

(75) Inventors: Banikumar Maiti, Escondido, CA (US); Sumanta Chakraborty, San Diego, CA (US); Suryakant Jhajhria, Escondido, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Communications, Inc.

(21) Appl. No.: 11/145,044

(22) Filed: Jun. 3, 2005

(51) Int. Cl. G06F 9/45

(52) U.S. Cl. 703/22

(57) ABSTRACT

Techniques for integrating always-on software applications are provided. A simulator for the software user interface interfaces with the always-on software application. The simulator operates similar to the software user interface, except that it does not affect the hardware user interface (e.g., the screen display). For example, the simulator user interface can execute a state machine that is the same as the software user interface. In this manner, the always-on software application drives the simulator software user interface when it is not in the foreground, which allows the simulator software user interface to direct the hardware user interface when the always-on application executes in the foreground.

### BACKGROUND OF THE INVENTION

The present invention relates to integrating software applications. More specifically, the invention relates to techniques for integrating always-on software applications in a platform that allows multiple software applications to run through switching contexts.

As the power of computer systems continues to grow, so too does the power of handheld devices. Some of the handheld devices have more processing power and storage capability than the early computers. Nevertheless, the platform differences (e.g., smaller screens and typically more limited input options) can create differences in the way software applications are executed.

Conventional computer systems allow for multitasking. This occurs when multiple software applications are executing simultaneously (e.g., through time-slicing). Typically, one of the software applications is in the foreground, while the others are in the background. It is fairly uncommon to find a software application for a computer system that is designed to be the sole software application executing on the platform. Such a software application will be called “always-on” (it can also be called “standalone”) software application because it is designed to have full access to the components of the platform at all times (i.e., always having full access to the display and inputs).

As handheld devices are often not general purpose machines, it is common to have stand-alone software applications for them. One such example is a push-to-talk (PTT) application that can be designed for a mobile telephone. The PTT application can be designed to be always on because it maintains a “friends list” of users that are online and processes events that are occurring in real-time. Such a stand-alone software application may be incompatible with executing other software applications at the same time.

One solution would be to rewrite or modify the always-on application so that it is no longer always-on and can execute with other software applications. Although this solution can be satisfactory in some situations, a platform integrator may not have access to the source code of the always-on software application. Additionally, the developer of the always-on software application may be unwilling to produce a different version of the application.

It would be beneficial to have innovative techniques of integrating always-on applications without requiring that the software application be modified. Additionally, it would be beneficial if the integration of the always-on software application did not require an inordinate amount of programming resources.

### SUMMARY OF THE INVENTION

The present invention provides innovative techniques for integrating always-on software applications. In general, a simulator for the software user interface (UI) interfaces with the always-on software application. The simulator operates similar to the software user interface, except that it does not affect the hardware user interface (e.g., the screen display). For example, the simulator user interface can execute a state machine that is the same as the software user interface. In this manner, the always-on software application drives the simulator software user interface when it is not in the foreground, which allows the simulator software user interface to seamlessly direct the hardware user interface when the always-on application executes in the foreground.

By providing a simulator software user interface, always-on software application be efficiently be integrated into desired platforms (e.g., handheld devices). The savings in developing (or redeveloping) always-on software applications can be utilized in other areas. Additionally, this allows for other always-on software application to be more easily ported to the platform. Some embodiments of the invention are described below.

In one embodiment, the invention provides a method of executing software applications that communicate with a user through a display through a user interface. A simulator for the user interface is provided, where the simulator maintains the state of the user interface without affecting the display for an always-on software application that is executing in the background. During times when the always-on software application is executing in the background, the simulator interacts with the always-on software application to maintain the state of the user interface as it would be if the always-on software application was executing in the foreground.

In another embodiment, the invention provides a method of executing software applications that communicate with a user through a display through a user interface. During times when an always-on software application is executing in the background, the always-on software application interacts with a simulator for the user interface, where the simulator maintains the state of the user interface without affecting the display. During times when the always-on software application is executing in the foreground, the always-on software application interacts with the user interface. Additionally, a message can case the always-on software application from executing in the foreground to background, or vice versa.

Other features and advantages of the invention will become readily apparent upon the review of the following description in association with the accompanying drawings. In the drawings, the same or similar structures will be identified by the same reference numerals.

### BRIEF DESCRIPTION OF THE DRAWINGS

FIG. 1 illustrates an embodiment of the invention that includes a simulator for the user interface that interacts with an always-on application that is executing in the background.

FIG. 2 shows an example of a flowchart of how user interface messages can be handled in the background and foreground.

FIG. 3 shows an example of a push-to-talk application executing in accordance with an embodiment of the invention.

FIG. 4 illustrates a block diagram of a handheld device, computer system or subsystems thereof that can utilize embodiments of the invention.

### DETAILED DESCRIPTION OF EMBODIMENTS

In the description that follows, the present invention will be described in reference to embodiments that integrate an always-on software application on a handheld device, such as a mobile phone. However, the invention is not limited to the specific implementations, applications or architectures described herein as the invention can be implemented in different ways. Therefore the description of the embodiments that follows is purposes of illustration and not limitation.

With the advances in semiconductors and miniaturization, modern handheld devices are nothing short of portable computer systems. Due to their smaller size, however, there can be some limitations when compared to their larger relatives. For example, the display on a handheld device is typically smaller than a desktop computer system. Additionally, the operating system may not be as robust.

As an example, many handheld devices may be designed to execute a single software application. For this or other reasons, a software application for an handheld device may be designed to be always-on executing in the foreground. If such an application is executed on a handheld device that is capable of executing multiple applications concurrently (e.g., one or more in the background), the capabilities of the handheld device are severely limited.

With an embodiment of the invention, the always-on application can execute in the background without requiring that the software application be rewritten or modified. As will be described in more detail below, a simulator for the user interface operates to maintain the state of the user interface while the software application is executing in the background. The display does not reflect changes in the user interface when the application is executing in the background.

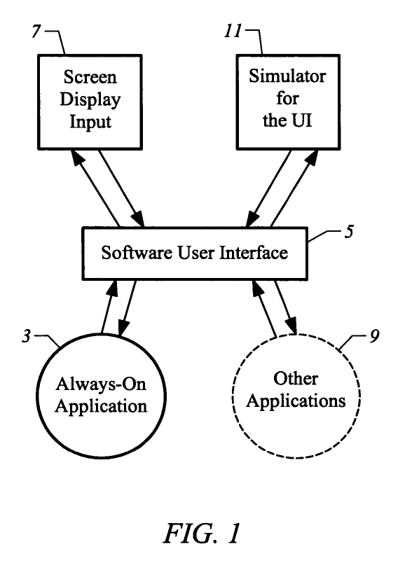

FIG. 1 illustrates an embodiment of the invention that includes a simulator for the user interface that interacts with an always-on application that is executing in the background. As shown, an always-on software application 3 interfaces with a software user interface 5, which then interfaces with a screen display (and input) 7. The user interface processes messages from applications and directs changes to screen display 7 when appropriate. Additionally, the user interface can receive messages as a result of user input, which are then directed to the applications.

Although the execution of always-on software application 3 is the main focus of the description herein, it should be understood that there may be one or more other software applications 9 that are also executing on the handheld device. Although the other applications are shown interfaces with the same software user interface 5, in other embodiments, they may interface with separate user interfaces, such as one specifically designed for that application.

During times when always-on software application 3 is operating in the foreground, the always-on software application communicates with a user through screen display 7 through user interface 5. Changes to the screen display are made where appropriate.

A simulator for the user interface 11 is provided that maintains the state of the user interface without affecting the screen display when the always-on software application is executing in the background. In this manner, the always-on software application is executing as if it was still in the foreground and the state changes to the user interface are maintained. Then, when the execution of the always-on software application changes or moves to the foreground, the user interface is in the right state.

In other words, the always-on software application need not be modified, but can be executed on a platform with other software applications, concurrently. Other advantages include that porting existing always-on software applications is significantly less time consuming.

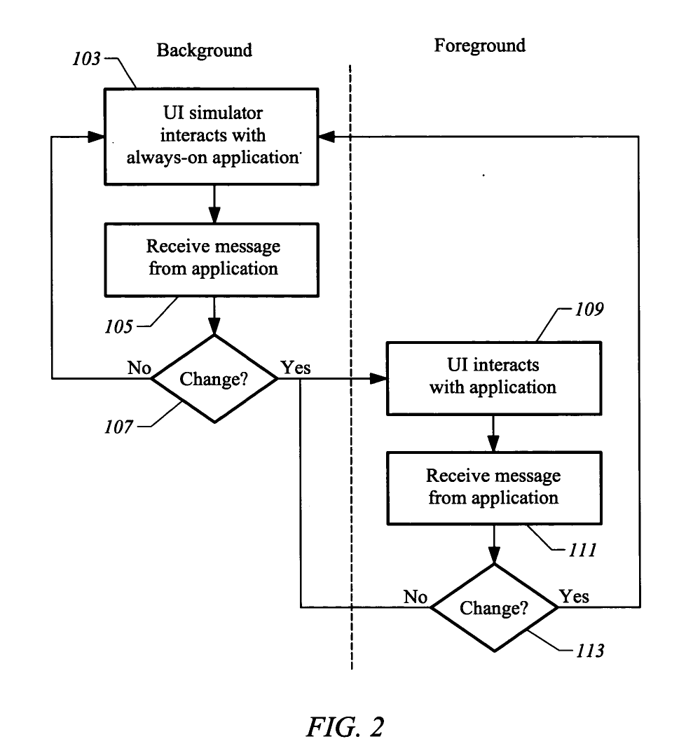

Now it may be beneficial to describe the flow in one embodiment. FIG. 2 shows an example of a flowchart of how user interface messages can be handled in the background and foreground. As with all the flowcharts shown herein, steps can be added, deleted, combined, and reordered without departing from the spirit and scope of the invention.

As shown, the steps in FIG. 2 are shown as being performed in the background or foreground. This designation refers to the execution mode of the always-on software application (i.e., not to the specific steps). Although the flow can begin with the application in the foreground or background, the steps will be described as starting in the background.

At a step 103, the user interface simulator interacts with the always-on application that is executing in the background. The simulator maintains the state of the user interface as if the application was executing in the foreground. Thus, although the user interface states are maintained, the screen display or other user interface hardware are not affected.

A message is received from the always-on application at a step 105. The message is typically a user interface message, but it could be other messages as well. At a step 107, it is determined if the message dictates a change in execution mode of the always-on software application. For example, there may be messages that would cause the application to be executed in the foreground. If not, the flow returns to step 103 for the user interface simulator to handle and maintain the user interface state accordingly.

If the message directs a change in execution mode so that the always-on application executes in the foreground, the user interface interacts with the application by handling the message at a step 109. This may include a drawing of the current screen on the display and updating the user interface according to the message. At this point, the application is executing in the foreground.

At a step 111, a message is received from the always-on application. It is determined if the message will cause a change in execution mode at a step 113. If not, the message is handled at step 109 with the application executing in the foreground. Otherwise, the flow returns to step 103 where the application returns to the background and the message is handled accordingly.

The above descriptions can be applied to any type software application. It may now be beneficial to discuss an application in some embodiments that is a push-to-talk always-on software application. Push-to-talk applications allow mobile phone users to talk directly to friends. It is typically implemented with a friends (or buddy) list of people, which is used as the pool of people of interest with whom to talk.

A push-to-talk application may be written as being always-on and it may be desirable to execute this application on a mobile phone without forcing the mobile phone to be constrained to solely this application. Also, it may be difficult or not cost effective to modify the application.

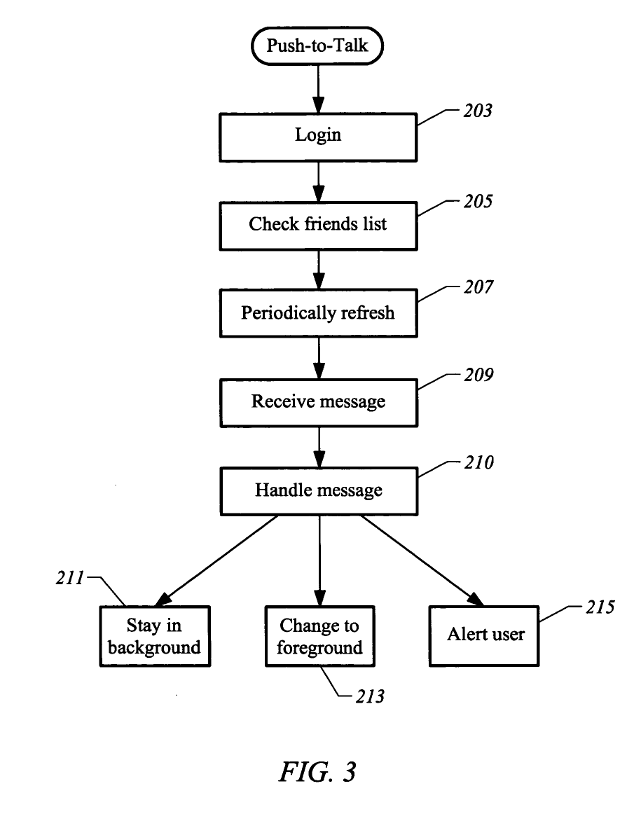

FIG. 3 shows an example of a push-to-talk application executing in accordance with an embodiment of the invention. At a step 203, the push-to-talk application logs in. This may include verifying the user and ensuring that push-to-talk capabilities are present. The user interface simulator may be designed to execute as much of the application in the background as possible. In such an embodiment, almost all the steps in FIG. 3 will be performed while the application is in the background. However, other embodiments can be designed in other ways.

The friends list is checked at a step 205. This step identifies the friends and then determines if those friends are online and available for push-to-talk interaction. The operational status and friends list may be periodically refreshed as shown by a step 207.

At a step 209, a message is received and the message is handled at a step 210. As mentioned above, steps 203 to 210 may be performed while the push-to-talk application is executing in the background.

There are many different types of messages and they can result in different changes of mode, but not all will. For example, a message that the connection is lost may be handled by retrying to establish the connection. The user interface simulator can handle the message while the push-to-talk application is executing in the background. In other words, the user need not be interrupted or informed that these actions are taking place.

At a step 213, the message that is handled could cause a change such that the push-to-talk application executes in the foreground. As an example, this could occur when someone on the friends list talks to them.

Additionally, the message could be handled and result in alerting the user as at a step 215. For example, a user may want to be notified when people on the friends list come online. A sound or other notification could be utilized to inform the user that something has transpired that the user may be interested in. The user could then bring the push-to-talk application to execute in the foreground, if desired. In some embodiments, there are different messages or events that could trigger different alerts to a user.

It is desirable to have the software user interface and the simulator for the user interface maintain the same state machines. In one embodiment this is implemented by having one software program implement both. A global variable that determines the mode that the always-on software application is executing (e.g., background or foreground) is maintained. If the variable specifies that the application is in the foreground, calls to the screen display (or from the user input) are not made. Otherwise, these calls are made. In this manner, the same computer code can be utilized to implement the software user interface and the simulator for the user interface.

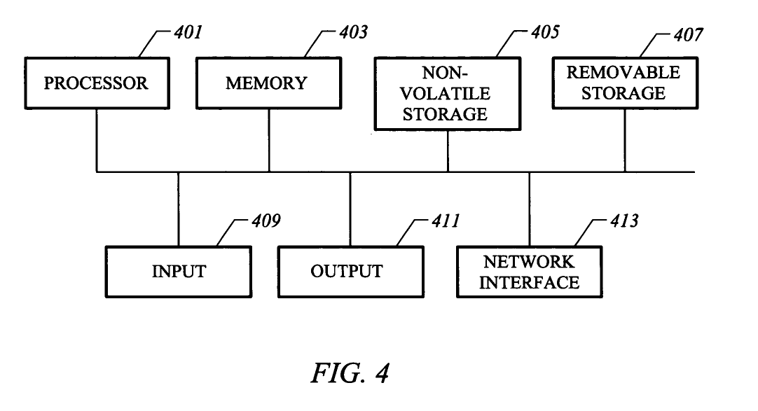

Now that an exemplary embodiments have been described, FIG. 4 shows a block diagram of components that can be present in a handheld devices, computer system or subsystems thereof that incorporate embodiments of the invention. A processor 401 executes code (or instructions) that direct the operation of the processor. Although processors typically have memory caches, processor 401 utilizes memory 403, which can store code and data.

A non-volatile storage 405 can store code and data such that it is typically persistent and provides more storage when compared to memory 403. At present, a common non-volatile storage is one or more hard drives. A removable storage 407 provides mobility to code and/or data that are stored thereon. Examples of removable storage are floppy disks, tape, CD/ROM, flash memory devices, and the like.

Memory 403, non-volatile storage 405 and removable storage 407 provide examples of computer readable storage media that can be utilized to store and retrieve computer programs incorporating codes that implement the invention, data for use with the invention, and the like. Additionally, a data signal embodied in a carrier wave (e.g., in a network including the Internet) can be the computer readable storage medium. An input 409 allows a user to interface with the system. Input can be done through the use of a keyboard, a mouse, buttons, dials, or any other input mechanism. An output 411 allows the system to provide output to the user. Output can be provided through a monitor, display screen, LEDs, printer or any other output mechanism. Input and/or output can also be performed externally through a network interface 413.

Network interface 413 allows the system to interface with a network to which it is connected. The components shown in FIG. 4 can be found in many network devices and computer systems. However, components can be added, deleted and combined so FIG. 4 is for illustration purposes. Additionally, these components can also be present on subsystems (e.g., line cards) in network devices and computer systems.

While the above are complete descriptions of exemplary embodiments of the invention, various alternatives, modifications and equivalence can be used. It should be evident that the invention is equally applicable by making appropriate modifications to the embodiment described above. Therefore, the above description should not be taken as limiting the scope of the invention by the metes and bounds of the following claims along with their full scope of equivalence.

What is claimed is:

1. A method of executing software applications that communicate with a user through a display through a user interface, comprising:
providing a simulator for the user interface, where the simulator maintains the state of the user interface without affecting the display for an always-on software application that is executing in the background; and
during times when the always-on software application is executing in the background, the simulator interacting with the always-on software application to maintain the state of the user interface as it would be if the always-on software application was executing in the foreground.

2. The method of claim 1, wherein when the always-on software application transitions from executing in the background to the foreground, the always-on software application interacts with the user interface.

3. The method of claim 1, wherein when the always-on software application transitions from executing in the foreground to the background, the always-on software application interacts with the simulator for the user interface.

4. The method of claim 1, wherein a message from the always-on software application alerts a user.

5. A computer program product that executes software applications that communicate with a user through a display through a user interface, comprising:
computer code that provides a simulator for the user interface, where the simulator maintains the state of the user interface without affecting the display for an always-on software application that is executing in the background;
computer code for the simulator that, during times when the always-on software application is executing in the background, interacts with the always-on software application to maintain the state of the user interface as it would be if the always-on software application was executing in the foreground; and
a computer readable medium that stores the computer codes.

6. The computer program product of claim 5, wherein the computer readable medium is a CD-ROM, floppy disk, tape, flash memory, system memory, hard drive, or data signal embodied in a carrier wave.

7. An apparatus that executes software applications, comprising:
a display;
a user interface that provides communication between software applications in the foreground and the display; and
a simulator for the user interface that maintains the state of the user interface without affecting the display for always-on software applications that are executing in the background.

8. A method of executing software applications that communicate with a user through a display through a user interface, comprising:
during times when an always-on software application is executing in the background, the always-on software application interacting with a simulator for the user interface, where the simulator maintains the state of the user interface without affecting the display; and
during times when the always-on software application is executing in the foreground, the always-on software application interacting with the user interface.

9. The method of claim 8, further comprising receiving a message to change the always-on software application from executing in the background to executing in the foreground.

10. The method of claim 8, further comprising receiving a message to change the always-on software application from executing in the foreground to executing in the background.

11. A computer program product that executes software applications that communicate with a user through a display through a user interface, comprising:
computer code that, during times when an always-on software application is executing in the background, interacts with the always-on software application to maintain the state of the user interface without affecting the display; and
computer code that, during times when the always-on software application is executing in the foreground, interacts with the always-on software application to affect the display; and
a computer readable medium that stores the computer codes.

12. The computer program product of claim 11, wherein the computer readable medium is a CD-ROM, floppy disk, tape, flash memory, system memory, hard drive, or data signal embodied in a carrier wave.

13. An apparatus that executes software applications, comprising:
a display; and
a user interface that provides communication between an always-on software application and the display if the always-on software application is executing in the foreground and maintains the state of the user interface without affecting the display if the always-on software applications is executing in the background.
